(19) United States
(12) Patent Application Publication
(10) Pub. No.: US 2014/0282076 A1
(43) Pub. Date: Sep. 18, 2014

(54) Online Proofing

(71) Applicant: William Fischer, Orange, CA (US)

(72) Inventor: William Fischer, Orange, CA (US)

(73) Assignee: Fisher Printing, Inc., Orange, CA (US)

(21) Appl. No.: 14/211,551

(22) Filed: Mar. 14, 2014

Related U.S. Application Data
(60) Provisional application No. 61/798,707, filed on Mar. 15, 2013.

(51) Int. Cl. G06F 3/0484; H04L 29/06

(52) U.S. Cl. CPC G06F 3/0484; H04L 65/40
USPC 715/751

(57) ABSTRACT

The present invention relates to an on-line application for advertising. More specifically, the present invention relates to an on-line portion or a web-based application that allows an artist working on an advertisement or other artistic work to provide a client with a preview of the advertisement. The application permits the client to provide comments directly, efficiently, and securely back to the artist. The client may highlight the areas that need modification, and may permit the client to add comments, files, renders, or other annotations to the artistic work.

### CROSS REFERENCE TO RELATED APPLICATIONS

This application claims priority to U.S. Provisional Application No. 61/798,707, titled “ONLINE PROOFING,” filed Mar. 15, 2013, which is incorporated in its entirety herein.

### FIELD OF THE INVENTION

Embodiments as described herein are directed to web-based applications. The web-based application may permit a user to view an artistic project, such as an advertisement, and an interface to indicate areas requiring further refinement. Accordingly, embodiments, as described herein may be used as an on-line proofing interface for artistic mediums including advertisements, brochures, etc.

### BACKGROUND

Typically, when a company employs a designer to configure a marketing or media campaign, ideas may be sketched out or preliminary renderings performed. However, at each iteration, a sample is usually generated and then physical edits are made to the sample. Each iteration is costly to produce and timely to correct and update.

For example, a company may have one or more ideas for creating their brand or image. The brand may include color schemes, logos, tag lines, brochures, advertisements, business cards, etc. The hired marketing company then designs various features incorporating the ideas from the company. The company and the marketer then meet to discuss the results and make changes. During the meeting, physical hard copy or digital presentations are generally brought to illustrate the various design features. If changes are discussed, it is generally to the designer to keep track of the suggestions, and incorporate them into later designs. The interaction is usually through the verbal descriptions and understandings between the parties. As such there is not always a clear record of the iterations, requests, and modifications made to any design concept. In later iterations, the discussions may even be remote, for example by teleconference, such that the company and designer are limited to verbal statements to express their desires and impressions of the work product. The verbal descriptions may be inadequate to properly express the true desires and intentions of either side. Therefore, misunderstandings and frustrations can arise during the revision process.

### SUMMARY OF THE INVENTION

Embodiments as described herein provide an on-line option or a web-based application that allows an artist working on an advertisement or other artistic work to provide a client with a preview of the advertisement. The application permits the client to provide comments directly, efficiently, and securely back to the artist. The client may highlight the areas that need modification, and may permit the client to add comments or simple renderings to express their desires with respect to the artistic work.

In an exemplary workflow, a user may first request an artistic work be created. The artistic work may include an advertisement, brochure, poster, artwork, etc. For an advertisement, a user may log-into a web-site. The web-site may take in information about what the client is seeking. Available templates, color schemes, block placement, regions, etc may be selectable by the user. Text or other input fields may be available for the user to enter in the text, slogans, etc. to be used in the advertisement. The portal may also permit a user to upload images to be used in the advertisement. Therefore, input logic may be configured to provide a user various fields to enter in desired information for creating the artistic work. These fields may be for pictures, prices, item descriptions, names, etc. The input logic may also permit a user to view and select templates including color schemes, fonts, layout orientations, etc.

To this end, in a exemplary embodiment of the present invention, an apparatus, comprising: an application resident on a client device that communicates over a network with a server and database, where the client device server system is configured to enable a user. to preview an artistic work, provide feedback on the artistic work, and approve the artistic work; a rendering application configured to display an artistic work to the user; a proofing application configured to permit a user to provide comments associated with the artistic work, the client device communicates the comments entered by the user over the network to the server; and an indicator application that sends a notice when the user provides feedback, wherein any portion of the server implemented in software and any software implemented on the client device are both stored on their own non-transitory computer readable medium in an executable format.

In an exemplary embodiment, wherein a user interface of the rendering application presents a low resolution rendering of the artistic work on a display screen of the client device.

In an exemplary embodiment, wherein a user interface of the proofing application is configured such that the user may provide markings directly on the displayed artistic work.

In an exemplary embodiment, wherein the proofing application is configured such that the user may provide written instructions regarding the artistic work.

In an exemplary embodiment, wherein the proofing application associates the rendering with the continents and stores the rendering and associated comments in a database associated with the server.

In an exemplary embodiment, further comprising a files application with a user interface for permitting a user to upload a file and associate the file with the artistic work.

In an exemplary embodiment, wherein the indicator application comprises a software program resident on the server that receives an indication from the client device that comments are complete, and sends an email to an identified email address alerting a designer that comments complete.

In an exemplary embodiment, wherein the indicator application comprises a user interface that identifies one or more notices for review by the user.

In an exemplary embodiment, wherein the markings include a geometric shape, a highlighting, or comment field.

Still in an exemplary embodiment, a computing device implemented method in a client-server environment, comprising: displaying an artistic work to the user on a client device that communicates over a network with a server and database; receiving comments from a user associated with the artistic work, the client device communicates the comments entered by the user over the network to the server; and sending a notice to a designer separate from the user when the user provides feedback.

In an exemplary embodiment, wherein the feedback includes providing written comments about the artistic work.

In an exemplary embodiment, wherein the feedback includes indicating a region of the artistic work to be modified.

In an exemplary embodiment, wherein the feedback includes highlighting a region of the artistic work to modify.

The method of claim 13, wherein an email is provided to alert the designer of the artistic work of the feedback.

Once the various selections are made, the user may submit the entry to a publishing company to create the requested artwork. Once submitted to the publisher, an artist or designer may be assigned to the job of creating the artwork using the information provided by the user. Once the designer has finished with the artwork, the designer may import a copy of the artwork to the web application. The copy may be a direct digital copy of the artwork, or may be a reduced resolution preview to permit easier and faster transfer. The reduced resolution preview should be of sufficient quality to provide the user sufficient detail to proof the artwork. Once uploaded to the web application, notification logic may notify the user that the artwork is available for viewing. The notification logic may send a text message, email message, or other electronic notification of the available preview.

The user may then navigate to the application and view the preview of the artwork. Comment logic permits the user to provide feedback to the designer. The comment logic may include preconfigured selections that the user may choose, such as drop down menus, check boxes, slide bars, text areas, etc. The user may also choose to directly annotate the drawing. In an exemplary embodiment, a user may highlight one or more regions of the drawing to indicate the location where modifications need to be made. Highlighting may be done through selecting areas of the rendering that are sub-divided and selected. Highlighting may also be done through adding circles, arrows, arcs, etc to the previewed artwork. Thus, the comment logic provides the user markers and commenting tools user comments and actions, and a preview screen to show the artwork as it would be printed. Marker tools may be presented as click boxes to select a given shape or indicator, such as squares, ovals, arrows, message pop-out, etc. Once selected, a user may put these marks directly on the available preview.

Once the user has reviewed the preview, the user may approve the artwork for publishing, or may request that modifications be made consistent with the comments. The notification logic may then notify the designer or publishing company that the artwork has been reviewed and a selection made. If the user chooses to have the artwork modified, then a notice, such as an email, text message or other electronic notification may be sent to the designer. The process may be repeated once the designer has made the requested modifications. The user may also choose to approve the artwork. The publisher then prints the artwork according to whatever preference was provided by the user.

The application may also include management logic that assists a user in creating a profile, sending alerts, creating categories to manage multiple requests, providing status updates, archive or otherwise back-up work in progress and completed projects, delete, edit, and create new projects.

### BRIEF DESCRIPTION OF THE DRAWINGS

FIG. 1 illustrates an exemplary workflow according to embodiments of the system.

FIG. 2 illustrates an exemplary user interface presented on a web browser as seen on a display of a computer, mobile device, or other networked electronic device.

FIG. 3 illustrates an exemplary user interface for previewing, commenting, editing, otherwise indicating a modification, and approving the artistic work.

FIG. 4 illustrates an exemplary user interface for providing alerts regarding the creative work.

FIG. 5 illustrates an exemplary user interface for identifying, uploading, downloading archiving, unarchivine, reviewing, etc. files to and/or from the system.

FIG. 6 illustrates an exemplary user interface for identifying, creating, editing, deleting, and organizing categories for assignment to one or more artistic work.

FIG. 7 illustrates a diagram of an embodiment of a client-server network environment to implement the system as described herein.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

As shown and described, an application is provided that is run on a computer or server and permits more than one user to interact with the same image of an artistic creation. For example, one user may post an artistic work, and another user may view the work and provide feedback and comments in a secure, efficient, and direct manner. Thus, the second user may provide markings, highlighting, color indications, lines, arrows, arcs, etc. directly on the posted artistic work.

In an embodiment, an application resident on the client device communicates over a network with a server and database. This client device-server system is configured to enable a user of the client device to present artistic works to a remote user, receive feedback regarding the works, and provide updates regarding the works. A module, such as an application on the mobile device or resident on the server, may be configured to present a user interface for uploading the artistic work, managing a collection of artistic works, soliciting feedback for the works, including providing marks, highlights, comments, and/or alerts for or about the work, in a secure and efficient manner. A user interface of the module presents a user with a menu for selecting a high level activity such as navigating between receiving alerts, reviewing proofs, identifying files, logging out, etc.

The client device communicates the content selected through the user interface over the network to the server potentially located on the World Wide Web. A software program resident on the server or integrated in the module at the client device takes the inputs from the user and stores them in the database for retrieval by another user.

Embodiments as described herein, may include a web-based system, such that each user is presented with a graphical user interface through a remote console, such as a desk top, lap top, smart phone, tablet, television, or other digital or mobile device, coupled to a network. The network may provide access to the internet in which the user may navigate to the website and exchange data between the website and the remote console. The system permits an artist to upload an artistic review to be removed by a customer at the remote console. The system then permits the customer at the remote console to preview and comment on the work in an easy, efficient, and secure manner. The system may be resident on the server and provide one or more module for executing the functions described herein.

FIG. 1 illustrates an exemplary workflow according to embodiments of the system. The exemplary workflow illustrates the interactions between the artistic designer and the customer or remote user to provide feedback between the two. Thus, an artistic work can be created, previewed, modified, and approved without costly and inefficient printing of multiple revisions.

The exemplary workflow is initiated at step 2 when a client, or user 101, requests the creation of an artistic work such as an advertisement, brochure, logo, etc. In an exemplary embodiment, the request may be made on-line through user interface. The user interface may permit the user to select a template. One or more templates may be used to select and/or dictate the placement of items, arrangement, and color schemes. The template may also permit selection of pictures, ad elements, price, and/or associated descriptions. The user 101 may be prompted to provide other information relevant to the artistic work, such as a list of items to be identified in the work. For example, the created work for an advertisement may include a list of goods for sale, and may prompt the user to include the name(s), description(s), and price(s) of the list of goods.

Once the request for ad from step 2 is submitted, an artist or designer 102 is assigned the job of creating the artistic work. In the case of an advertisement, the ad designer may use a page layout program like Adobe InDesign to create the ad Thus, at step 4, the ad designer 102 creates the artistic work, such as the requested advertisement. Once the ad designer is finished with the design, the designer makes a low-resolution preview of the artistic work available for approval using the system.

Once the ad designer 102 has created the preview work for review by the user, at step 6, the user 101 is notified that the requested artistic advertisement is ready to view. The user may be alerted by email, text, or phone message. The user may be prompted at the request stage for contact information and preferences for receiving the notification.

At step 8, the user may review the artistic work through the website. The user may have created an account or logged into an account when making the advertisement request. Accordingly, the system may track and present a list of requests from the user for viewing at the discretion of the user. Once the user has selected an artistic work for preview, the system through one or more user interfaces, permits the user to provide feedback to the ad designer 102 by providing comments, and/or annotations to the previewed artistic work. The user 101 for example may add text comments, highlight areas of the ad that need to be modified, or provide other annotations directly on, over, or adjacent to the previewed advertisement. When the user is finished adding comments (if any), the client ends the preview session by either approving the artistic work or asking for a modification.

The designer of the artistic work is notified of any comments made by the user and the cycle of modify, preview, provide comments, or approve continues until the user is satisfied, and at step 10 approves the artistic work. Once the artistic work is approved, the artistic work is provided to the printing process for high quality rendering for the user's inspection or receipt, at step 12.

The user 101 generally interacts with the system through a user interface of a website presented through a web browser. The user interface may first present the user with a login screen, such that the system can be authenticated to the server. The user can provide, for example, a user name and password. The system may also permit the user to request a forgotten password and/or reset a password, register as a new user, or login. When creating a new user account, the system may prompt the user to enter, for example, identification information, such as name and client number, contact information, such as email address or address, and login information, such as user name and password. The user may also be prompted for other information, or given an opportunity through a general text input to provide desired information, such as notes.

FIG. 2 illustrates an exemplary user interface presented on a web browser as seen on a display of a computer, mobile device, or other networked electronic device. Once the user 101 has been authenticated by the system, for example, after having provided a login and password, the user gains access to the system. The system presents a user interface that displays the list of artistic works for review and approval. The user interface provides information to the user for selection through one or more icons, drop down boxes, text boxes, buttons, selection links, or other input/output interface.

In an exemplary embodiment, the user interface may provide one or more page tabs to permit the user to navigate between different displays providing different information to the user. The page selection may be separated from other input selection options as the user selects different views comprising different information. Exemplary page tabs may include:

Alerts 22: The alerts may provide a list of various alerts provided by the system to notify the user of events. The events may be related to specific projects such as providing a user notice of availability of new proofs 24 or uploaded files 44, status updates, or project changes, etc. Events may be related to system profiles, user configurations, or user accounts, such as invoice updates, access or account changes, etc. Events may be related to system or maintenance notices providing information on upgrades, updates, or other system alerts, etc. The alerts may be provided in duplicate form, such as sent by email, text, or other notice as set by the user, and archived for the user's convenience at the alerts page.

Proofs 24: The proofs page permits the user to see a list of artistic works that are currently active. The proofs page is displayed in FIG. 2. The proofs page provides a list and one or more options available for the respective proof. The proof page options are described more fully below.

Files 26: The files page identifies a list of files available for download. The files page can permit the user to download one or more selected files, may identify or track when a file was last downloaded, or alert a user when a new download is available.

Categories 28: The categories page allows the user to assign categories to creative works such that large requests or portfolios may be managed easier. The categories allows the user to add, delete, and edit categories as well as permit the user to select various creative works to be added or moved between categories.

Log Out 30 permits the user to log out of the system. To reinitiate a session, the user would have to revalidate themselves to the system, such as presenting a valid user name and password. After log out, the system will prevent the user or later users on the device to access the system and make edits, changes, or view the one or more user interfaces and/or files associated with the user account.

The system may also provide a number of drop down or user selection or input mechanisms for searching or presenting a desired selection of creative works or other information depending on the selected page. As shown, exemplary filters are presented as drop down selections that permit a user or designer to choose a selection from a pre-existing list associated with the login credentials of the given user and/or designer. Exemplary filters or selection options are presented below:

Client 32: The client selection option permits either the user 101 or the ad designer 102 to select a desired set of creative works associated with a respective client. Therefore, either the ad designer 102 or the user 101 may select all of the artistic works requested, created, approved, or otherwise available for a given classification based on client.

Category 34: The category permits the user 101 or ad designer 102 to filter the creative works by an assigned category. As mentioned above, the category page permits the user to associate a given work with a category for filtering by the exemplary drop down.

Status 36: The status filter can identify or display creative works by the status of the creative work within the system. Exemplary statuses may include current creative works in which the creative work is currently being created, reviewed, or approved; archived in which the user has selected to terminate the creative work as either approved or abandoned; or all, which includes both current and archived works. Other status identifiers may be created associating the creative work with various stages of implementation, such as request (identifying those creative works that have been requested), drafted (identifying those creative works that have initially been drafted but not reviewed), reviewed and/or edited (identifying those creative works in some various stage of review by the user), edited (identifying those creative works sent back to the draftsman for modifications, edits, or updates, in which the status will be reset once redraft by the draftsman), approved (identifying those that have been approved by the user), and/or abandoned (identifying those works that were terminated prior to approval). Other status categories are contemplated and within the scope of the disclosure as necessitated by the stages of a given user and/or designer.

Items per page 20: The items per page selection allows the user and/or designer to identifying how many items to list on a given page.

The user and/or designer may be presented with select user options for the given page and/or information presented to the user for a given user interface. The exemplary illustration is provided for the proofs page in which a number of creative works are presented to a user. The user is presented with a number of options for a given creative work that may be provided to the system through a selection in bulk, such as by selecting one or more check boxes 54 associated with any one or more listed creative work, and then the selection of an associated action button (for example, 40, 42, 44, . . . ). Alternatively, a user may use a given action icon associated with individually listed creative works, such that the icon identifies both the action to be performed and the respective creative work associated with the action. The available actions may be duplicated as one or more icons, buttons, selections, etc. Exemplary action items are presented below:

View 40 and 40′: The view event permits a user and/or designer to select one or more creative works to preview. The viewing option may illustrate the creative work to the user and permit the user to provide comment to the designer through one or more additional functions for editing, commenting, annotating, highlighting, etc. The view page may also provide the user with the option to approve the work or send the edits back to the design for modification. The user may select the view option through a bulk selection through a view button 40 in combination with selecting one or more listed creative works, such as by check box 54, or by selecting an associated icon 40′ to a given single listed creative work.

Download 42 and 42′: The download event permits a user and/or designer to download the low resolution or created preview to a digital file. The file may be an image or data file, such as PDF, TIFF, JPEG, etc. Downloading a sample creative work permits the user to print a local copy or send it to other users for comment or feedback. The system may incorporate one or more security features to prevent or reduce reproduction of the creative work without authorization. For example, a copyright notice or company watermark may be incorporated into the downloaded file, or onto the downloaded image.

Upload 44: The user and/or designer is permitted to upload one or more files to the system and associate the one or more files to a creative work. The files may include new or substitute images, for example, for incorporating, replacing, or modifying portions or all of the proposed creative work. For example, the user can upload a new image with a comment to replace certain items contained in the creative work.

Archive 46 and 46′: The user and/or designer may designate one or more files through the bulk process button of 46 or individual icon selection associated with a listed creative work 46′ for placing in an archive. The archive may remove the creative work from the active or current project listings, but keep the creative work saved in the system for review and/or retrieval at a later time. The archive feature may be beneficial when a project is postponed or temporarily demoted in terms of priority. Alternatively, the archive feature may be used when a project or creative work may be reused at periodic iterations. For example, if a company holds an annual or semi-annual sale of the same products, the creative work associated with that sale may be archived when the promotion is not being held, but unarchived to update the creative work and update the work with relevant information for the present iteration.

Unarchive 48: Similar to the archive event, unarchive permits a user and/or designer to designate one or more creative works as current or active, and remove the work from the archive list. Therefore, a given creative work is moved from the archive area to the active current queue.

Delete 50: The delete event removes the creative work from the system.

The list of artistic works available for the above described functions may be listed for selection by the user. The list may provide desired information about the respective artistic work. For example, the proof name 56 of the artistic work, date and/or time of last edit 58, whether the artistic work is approved 60, and whether the artistic work is archived 62. Other information may be displayed as necessitated or desired by the user and/or designer. The associated icons, such as check box 54, view 40′, download 42′, or archive 46′ may also be listed with the associated artistic work.

The availability and/or visibility of one or more event options, identified above, may be present depending on the selection of other criteria. For example, when the filter feature of “Current” is selected, then the option event to “unarchive” a creative work may not be available since all of the listed options are already in active status. When a filter, event, or other feature is unavailable because of the selection of one or more other filters, events, pages, or other feature that unavailable feature may not be displayed to the user or may otherwise visually indicate its unavailability. For example, the unarchive button 48 may be greyed out when the filter option of “current” is selected.

Once the user selects and views a creative work, the user is permitted (by clicking the view event associated with a creative work) to comment, highlight, annotate, etc. areas of the creative work to be modified. The designer is then alerted to work on the creative work and the cycle of review-comment-edit continues until the user is satisfied with the contents and the creative work is approved for printing.

FIG. 3 illustrates an exemplary user interface for previewing, commenting, editing, otherwise indicating a modification, and approving the artistic work. The exemplary preview user interface may correspond to the proofs page after an identified artistic work has been selected by the user and/or designer.

The preview page permits the user to provide comments, annotations, indications, or other inputs or alerts to the designer. The preview provides the user with a number of tools for providing the desired information to the designer. For example, the preview user interface may provide a number of tools such as annotating tools, commenting tools, and preview tools.

The preview tool permits the user to view the artistic work, scroll through various pages, zoom the image, etc. For example, a preview pain 82 may depict a representation of the artistic work. The representation may be a digital copy of the artistic work, a low resolution image, or block layout of the artistic work for review by the user. Various navigation options may be provided to the user, such as selecting or scrolling page numbers 64, or zooming or setting the page size 66. The user can also approve 70 or archive 72 a previewed artistic work by selecting the appropriate option. The user can indicate when the edits are also completed 76, such that the designer is alerted to the comments and edits, and can then restart the design, review, approve process. If approved, the designer may be alerted such that final processing and printing can occur.

The annotating tools may permit the user to select one or more annotations including, highlights, rectangles, ovals, arrows, comment icons, or other indications for imposition over the artistic work. The annotating tools may be presented as drop down options, such as to choose colors 74, or as icons 68. The exemplary icons 68 include features for selecting a pointed. The pointer may be used to select annotations, areas of the preview, or other functions or user interface input/output options. If, for example, an annotation is selected, the user may then delete, move, resize, or change its color. The rectangle permits the user to draw an empty rectangle around an area of the preview. The filled rectangle permits the user to draw a rectangle with a colored or highlighted interior around an area of the preview. The same open and filled circle options may also be provided to the user. Other shapes such as stars, lines, polygons, ovals, etc. may also be provided by the user. Other exemplary shapes include a callout bubble or arrow. A delete or garbage icon permits the user to select an annotation and delete it from the preview.

The commenting tool may permit the user to provide written comments to the designer. The comments may be tagged to another annotation such that a circled item may include the associated comment identifying the deficiency with the circled area of the artistic work. The comments may also be general to the entire artistic work. The comments may also track a specific user, as well as the date and time the comment was added to the system. Comments may be provided through a text box, call out, or other annotating feature to permit a user to specifically identify the desired modification associated with the preview or with a specific annotation created on the preview. Thus, an option may be provided to add a comment 78, and preview a list of comments 80 associated with the preview. If multiple users are reviewing the same artistic work, the comments and annotations may be linked such that each user may or may not see select other users. The comments of others may also be selectively turned on or off by any one user, such that a user can obtain an unbiased review of the artistic work or can continue work started by another user.

The complete tool 76 permits a user to indicate when one or all of the users have finally reviewed the work and/or approved the work such that the designer is notified of either approval or modifications. The system may be configured that a number of users are identified with any one artistic work such that comments or approvals (i.e. the approve or complete tool) must be detected for each user before an alert is provided to the designer. Alternatively, a single user may dictate for all users when the review process in over, and by any one or more individual user indicating that the review is complete, the designer is alerted.

FIG. 4 illustrates an exemplary user interface for providing alerts regarding the creative work. The viewing area permits the user to see a list of alerts and associated details. The details may include file names, date and time of the associated alert or event, the associated user or designer performing or requesting the action, etc. Similar to the other user interface pages, the user may be presented with a number of bulk processing or individual processing options to manage the listed alerts. For example, the alert may be viewed 84, ignored 86, ignored in bulk 88, or deleted 50.

The user may also select the preferences to configured the alerts display and/or how the alerts are provided. For example, a user may select one or more categories of alerts, such as for example, new proof uploaded, proof edited, proof reviewed, proof approved, new file uploaded, etc. The selected alert may then be configured to alert the user in one or more ways, such as by email, text, only on alert page, etc. and provide the necessary information to complete the request alert.

FIG. 5 illustrates an exemplary user interface for identifying, uploading, downloading archiving, unarchivine, reviewing, etc. files to and/or from the system. The user interface may be used to provide options and/or information about the files associated with a given artistic work or user work list. In an exemplary embodiment, the user interface permits a user to upload a file and associate comments with the file.

FIG. 6 illustrates an exemplary user interface for identifying, creating, editing, deleting, and organizing categories for assignment to one or more artistic work.

FIG. 7 illustrates a diagram of an embodiment of a client-server network environment to implement the system as described herein. An application resident on the client device 110A-110C communicates over a network 100 with one or more servers 105A-105C and their databases 106A-106C. This client device-server system is configured to enable a user of the client device 110A-110C to conduct the artistic work preview and proofing as described herein. The client devices such as a smart phone 110A, Personal Digital Assistant/Tablet 110B, Laptop computer 110C may have a browser application resident along with one or more client applications scripted to run the system operations and cooperate with the server.

The server, such as a first server 105A, maintains the artistic work, comments, annotations, user information and preferences, etc. When the server is an internet site, the server may service one of a traditional website and may be comprised of at least one or more servers and cooperating databases. This new, simple, and efficient manner of receiving, previewing, commenting, and approving artistic works enables anyone to easily manage work product. A module, such as a client application on the mobile client device or server applet resident on the server, may be configured to present the one or more user interfaces and associated functions etc. as described herein. The client application has code scripted to present one or more user interface pages that permits the user to receive, retrieve, and provide information and data which is configured to work with a browser and a remote server. The server applet works with a browser application resident on the client device and serves one or more web pages 110 to the client device with the resident browser.

The application may be a web-based application that is run on a web-browser. The proofing application may be implemented with combinational logic and finite state machines in a logic device. A logic device, for example, may include Application Specific IC (ASIC), or a Field Programmable Gate Array (FPGA), or processors, or any combination thereof. The proofing logic may be configured to permit a client to provide proofing instructions to an artist. Proofing instructions may include marking a rendering of the artistic work, providing written comments, highlighting, indicating an area of the work to modify, or expressing modifications to the work through words, letters, markings, renderings, annotations, geometric shapes, etc. The proofing logic is performed by processing logic that may comprise hardware (circuitry, dedicated logic, state machines, etc.), software (such as to run on a general purpose computer system or a dedicated machine), or a combination of both. The proofing logic may comprise input logic, notification logic, comment logic, management logics as describe herein. A special purpose computer may be programmed to perform the disclosed one or more algorithms.

While some specific embodiments of the invention have been shown the invention is not to be limited to these embodiments. For example, most functions performed by electronic hardware components may be duplicated by software emulation, and vise verse. Thus, a software program written to accomplish those same functions may emulate the functionality of the hardware components in input-output circuitry. The invention is to be understood as not limited by the specific embodiments described herein, but only by scope of the appended claims.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. An apparatus, comprising:
an application resident on a client device that communicates over a network with a server and database, where the client device server system is configured to enable a user to preview an artistic work, provide feedback on the artistic work, and approve the artistic work;
a rendering application configured to display an artistic work to the user;
a proofing application configured to permit a user to provide comments associated with the artistic work, the client device communicates the comments entered by the user over the network to the server; and
an indicator application that sends a notice when the user provides feedback,
wherein any portion of the server implemented in software and any software implemented on the client device are both stored on their own non-transitory computer readable medium in an executable format.

2. The apparatus of claim 1, wherein a user interface of the rendering application presents a low resolution rendering of the artistic work on a display screen of the client device.

3. The apparatus of claim 1, wherein a user interface of the proofing application is configured such that the user may provide markings directly on the displayed artistic work.

4. The apparatus of claim 3, wherein the proofing application is configured such that the user may provide written instructions regarding the artistic work.

5. The apparatus of claim 3 wherein the proofing application associates the rendering with the comments and stores the rendering and associated comments in a database associated with the server.

6. The apparatus of claim 5, further comprising a files application with a user interface for permitting a user to upload a file and associate the file with the artistic work.

7. The apparatus of claim 1, wherein the indicator application comprises a software program resident on the server that receives an indication from the client device that comments are complete, and sends an email to an identified email address alerting a designer that comments complete.

8. The apparatus of claim 7, wherein the indicator application comprises a user interface that identifies one or more notices for review by the user.

9. The apparatus of claim 3, wherein the markings include a geometric shape, a highlighting, or comment field.

10. A computing device implemented method in a client-server environment, comprising:
displaying an artistic work to the user on a client device that communicates over a network with a server and database;
receiving comments from a user associated with the artistic work, the client device communicates the comments entered by the user over the network to the server; and
sending a notice to a designer separate from the user when the user provides feedback.

11. The method of claim 10, wherein the feedback includes providing written comments about the artistic work.

12. The method of claim 11, wherein the feedback includes indicating a region of the artistic work to be modified.

13. The method of claim 12, wherein the feedback includes highlighting a region of the artistic work to modify.

14. The method of claim 13, wherein an email is provided to alert the designer of the artistic work of the feedback.
